(19) United States
(12) Patent Application Publication
(10) Pub. No.: US 2013/0022704 A1
(43) Pub. Date: Jan. 24, 2013

(54) Mold-Tool Assembly Including Resin-Retaining Device Located Relative To Stem-Tip Portion

(71) Applicant: Edward Joseph Jenko, Essex, VT (US)

(72) Inventor: Edward Joseph Jenko, Essex, VT (US)

(73) Assignee: HUSKY INJECTION MOLDING SYSTEMS LTD., Bolton, ON (CA)

(21) Appl. No.: 13/638,939

(22) PCT Filed: Mar. 24, 2011
(86) PCT No.: PCT/US11/29693

§ 371 Date: Oct. 2, 2012

Related U.S. Application Data
(60) Provisional application No. 61/320,789, filed on Apr. 5, 2010.

(51) Int. Cl. B29C 45/23

(52) U.S. Cl. 425/562

(57) ABSTRACT

A mold-tool assembly (100), including a stem-tip portion (102), and also including a resin-retaining device (104) being located relative to the stem-tip portion (102).

### TECHNICAL FIELD

An aspect of the present invention generally relates to (but is not limited to) a mold-tool assembly, including (nit not limited to) a resin-retaining device located relative to a stem-tip portion.

### BACKGROUND

The first man-made plastic was invented in Britain in 1851 by Alexander PARKES. He publicly demonstrated it at the 1862 International Exhibition in London, calling the material Parkesine. Derived from cellulose, Parkesine could be heated, molded, and retain its shape when cooled. It was, however, expensive to produce, prone to cracking, and highly flammable. In 1868, American inventor John Wesley HYATT developed a plastic material he named Celluloid, improving on PARKES' invention so that it could be processed into finished form. HYATT patented the first injection molding machine in 1872. It worked like a large hypodermic needle, using a plunger to inject plastic through a heated cylinder into a mold. The industry expanded rapidly in the 1940s because World War II created a huge demand for inexpensive, mass-produced products. In 1946, American inventor James Watson HENDRY built the first screw injection machine. This machine also allowed material to be mixed before injection, so that colored or recycled plastic could be added to virgin material and mixed thoroughly before being injected. In the 1970s, HENDRY went on to develop the first gas-assisted injection molding process.

Injection molding machines consist of a material hopper, an injection ram or screw-type plunger, and a heating unit. They are also known as presses, they hold the molds in which the components are shaped. Presses are rated by tonnage, which expresses the amount of clamping force that the machine can exert. This force keeps the mold closed during the injection process. Tonnage can vary from less than five tons to 6000 tons, with the higher figures used in comparatively few manufacturing operations. The total clamp force needed is determined by the projected area of the part being molded. This projected area is multiplied by a clamp force of from two to eight tons for each square inch of the projected areas. As a rule of thumb, four or five tons per square inch can be used for most products. If the plastic material is very stiff, it will require more injection pressure to fill the mold, thus more clamp tonnage to hold the mold closed. The required force can also be determined by the material used and the size of the part, larger parts require higher clamping force. With Injection Molding, granular plastic is fed by gravity from a hopper into a heated barrel. As the granules are slowly moved forward by a screw-type plunger, the plastic is forced into a heated chamber, where it is melted. As the plunger advances, the melted plastic is forced through a nozzle that rests against the mold, allowing it to enter the mold cavity through a gate and runner system. The mold remains cold so the plastic solidifies almost as soon as the mold is filled. Mold assembly or die are terms used to describe the tooling used to produce plastic parts in molding. The mold assembly is used in mass production where thousands of parts are produced. Molds are typically constructed from hardened steel, etc. Hot-runner systems are used in molding systems, along with mold assemblies, for the manufacture of plastic articles. Usually, hot-runners systems and mold assemblies are treated as tools that may be sold and supplied separately from molding systems.

U.S. Pat. No. 4,212,625 discloses a high speed injection molding machine having a nozzle structure surrounded by an air gap into which working material may exude? to form a seal.

U.S. Pat. No. 6,214,275 discloses an injection nozzle for an injection molding plastic resin from a source of molten resin to a mold cavity.

U.S. Pat. No. 6,220,850 discloses a mold gate insert for an injection molding machine that has a first portion formed from a wear resistant, low thermally conductive material, and a second portion formed from highly thermally conductive material.

U.S. Pat. No. 7,037,103 discloses an injection molding apparatus for injection molded articles, including a replaceable insert installed in a cavity plate adjacent a vestige and having a gate with a passageway and a sealing portion with smaller diameter than the vestige.

U.S. Pat. No. 7,547,404 discloses an injection molding system and an adapted dispensing apparatus to function with the molding system to deliver a coating composition into the mold when the mold sections are in closed condition.

U.S. Pat. No. 2003/082266 discloses a nozzle system for an injection molding machine, including a nozzle body, a nozzle tip, and a sealing and a mounting element for mounting a nozzle tip to the nozzle body.

U.S. Pat. No. 2004/058031 discloses an injection molding apparatus for injection molded articles, including a replaceable insert installed in a cavity plate adjacent a vestige and having a gate with a passageway and a sealing portion with smaller diameter than the vestige.

U.S. Pat. No. 2008/241300 discloses a nozzle structure for an injection molding apparatus, which has a nozzle that enters into a large recess portion of a split mold, so that a portion of the nozzle is housed in the large recess portion.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

There are persistent problems in the hot runner industry related to usage of a plunger type valve stem. There is a necessary space between the cylindrical portion of the stem end and the cavity gate diameter. As built the space is typically quite close (5 to 10 microns or less) and therefore the surface is normally made using a high precision machine resulting in a very smooth surface finish, approaching the finish of a highly polished surface. Because the molten plastic in the gate diameter is displaced by the motion of the stem coming into the cavity, plastic is wedged in the gap between the stem cylindrical end and the gate diameter. When the molded part is sufficiently cooled to permit de-molding, the plastic in the stem/gate gap can tend to be “pulled” out of the gap by the molded article and results in a witness ring, often referred to as a “crown” or crown witness, which is unwanted or undesirable. The crown witness is usually noticeable and degrades the aesthetics of the molded article. With the gate orifice and the cylindrical stem end being of polished texture, it disadvantageously promotes the plastic to slip out with the molded article.

To resolve the above problem, according to one aspect, there is provided a mold-tool assembly (100), including a stem-tip portion (102), and also including a resin-retaining device (104) being located relative to the stem-tip portion (102). The technical effect of the foregoing solution is to reduce the amount of the crown witness on the molded article thereby improving the aesthetics of the molded article.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

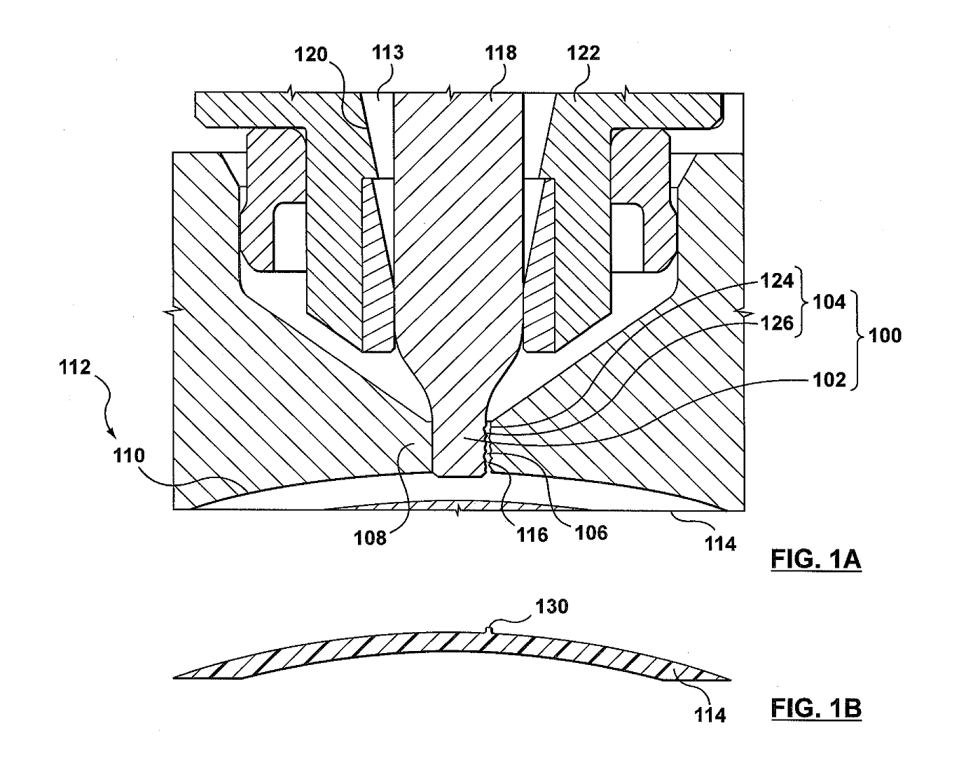

FIG. 1A depicts a schematic representation of a mold-tool assembly (100);

FIG. 1B depicts a schematic representation of a molded article (114) made by using the mold-tool assembly (100) of FIG. 1A; and

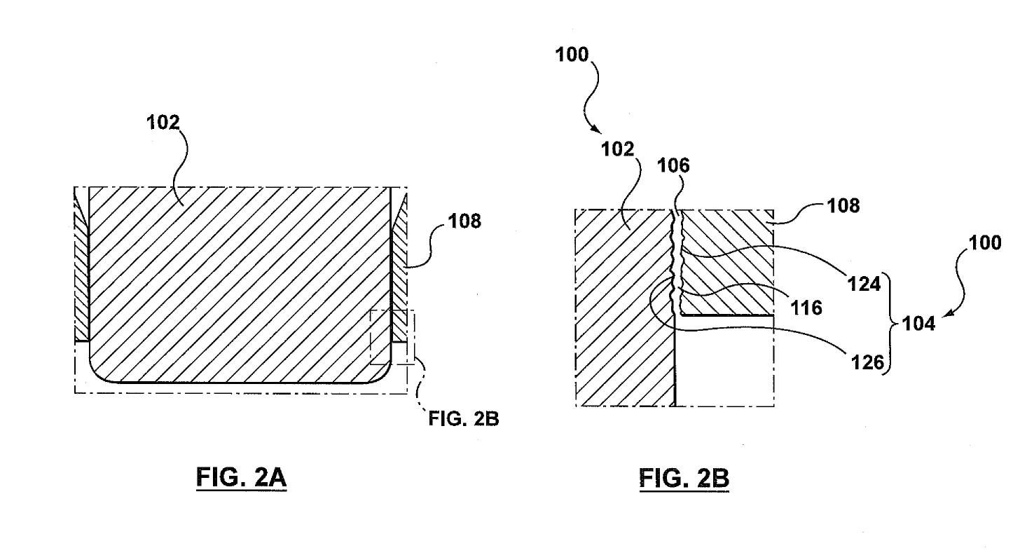

FIGS. 2A and 2B depict close-up views of the mold-tool assembly (100) of FIG. 1A.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIG. 1A depicts the schematic representation of the mold-tool assembly (100). The mold-tool assembly (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The mold-tool assembly (100) includes (but is not limited to): (i) a stem-tip portion (102), and (ii) a resin-retaining device (104). The resin-retaining device (104) is located relative to the stem-tip portion (102). The stem-tip portion (102) is movable between an open position (in which resin may flow) and a closed position (in which resin is prevented from flowing). The stem-tip portion (102) extends from a valve stem (118). The valve stem (118) is slidably received in a melt passageway (120) of a nozzle body (122). More specifically, the stem-tip portion (102) is configured to interact with a gate orifice (106) that is defined by a gate body (108). The meaning of “interact” is that the stem-tip portion (102) is movable relative to the gate orifice (106). The gate orifice (106) leads to a mold cavity (110) that is defined by a mold assembly (112). The mold cavity (110) is configured to: (i) receive a resin (113), and (ii) form a molded article (114). For the case where the stem-tip portion (102) is moved to the open position, resin (113) may flow into the mold cavity (110), and for the case where the stem-tip portion (102) is moved to the closed position, the resin (113) is prevented from flowing into the mold cavity (110).

In a first operation, the stem-tip portion (102) is placed in the open position, so that the stem-tip portion (102) is moved away from the gate orifice (106), thereby permit the resin (113) to fill the mold cavity (110).

In a second operation, the stem-tip portion (102) is placed in the closed position, so that the stem-tip portion (102) is moved so as to become located in the gate orifice (106) thereby prevent the flow of the resin (113). It will be understood that in the closed position of the stem-tip portion (102), a gate-residing resin (116) is located in the gate orifice (106) in response to the stem-tip portion (102) being located in the gate orifice (106). In addition, the gate-residing resin (116) is connected with the molded article (114) that is formed in the mold cavity (110). The arrangement of the mold-tool assembly (100) causes a minimal amount of the gate-residing resin (116) to become removed from the gate orifice (106) for the case where the molded article (114) is to be removed from the mold cavity (110). More specifically, the resin-retaining device (104) is configured to retain, at least partially, the gate-residing resin (116) in response to the molded article (114) breaking apart from the gate-residing resin (116) as the molded article (114) moves away from the gate orifice (106) during a de-molding operation. During the de-molding operation, the molded article (114) will be removed from the mold cavity (110). And the amount of the crown witness created on the molded article (114) that does become de-molded is minimized (as depicted in FIG. 1B).

By way of example, the resin-retaining device (104) may include (but is not limited to) a mold-gate textured surface (124) being located on the gate body (108) in the gate orifice (106), and the mold-gate textured surface (124) facing the stem-tip portion (102) once the stem-tip portion (102) moved proximate to the mold-gate textured surface (124).

By way of another example, the resin-retaining device (104) may include (but is not limited to) a stem-tip textured surface (126) being located on the stem-tip portion (102), and the stem-tip textured surface (126) facing the gate body (108) in the gate orifice (106) once the stem-tip portion (102) is moved proximate to the gate body (108).

By way of yet another example, the resin-retaining device (104) may include (but is not limited to) the combination of using both: (i) the mold-gate textured surface (124), and (ii) the stem-tip textured surface (126).

The mold-gate textured surface (124) and the stem-tip textured surface (126) may be manufactured as non-smooth surfaces by sand (grit) blasting process, an etching process, an Electronic Discharge Manufacturing (EDM) process, grooving and laser ablation, grit blasting, and/or machining, etc. A textured surface may be manufactured and/or applied. The definition of “textured surface”: is a surface that has enough roughness (roughness) that provides the function of gripping or retaining the gate-residing resin (116) as much as possible, so as to cause a minimal amount of crown witnessing on the molded article (114). The textured surface may be placed on an inner surface surrounding the gate orifice (106), and/or may be placed on an outer surface of the stem-tip portion (102). As the stem and/or gate wears, the textured surface may be reapplied so as to rejuvenate the resin-retaining device (104). The mold-tool assembly (100) may also advantageously improve economical manufacturability by permitting an increase of tolerances and gap clearance. Accordingly, a more aggressive texturing of the surfaces may also be used, and this arrangement may be particularly advantageous for gate inserts with very aggressive cooling, etc.

FIG. 1B depicts the schematic representation of a molded article (114) made by using the mold-tool assembly (100) of FIG. 1A. Texturing of the outer surface of the stem-tip portion (102) helps to promote a gripping undercut in the resin that resides in a gap that is located between the stem-tip portion (102) and the diameter of the gate orifice (106). The gripping undercut may help provide a gripping resistance that prevents the resin located in the gap from being pulled out, attached to the molded article (114). The gripping undercut causes a tear at an intersection of a cavity molding surface and the stem-tip portion (102), resulting in a cleaner tear and/or reduced crowning witness (130) on the molded article (114).

FIGS. 2A and 2B depict close-up views of the mold-tool assembly (100) of FIG. 1A. It will be appreciated that FIG. 1A depicts the molded article (114) located in the mold cavity (110) with the valve stem (118) placed in a closed position. FIG. 2A depicts a close up of the mold-tool assembly (100) and the gap (that is, a clearance) between the stem-tip portion (102) and the gate orifice (106). FIG. 2B depicts a textured surface on the stem side of the gap to provide the resin-retaining device (104), which may be called a grip device. The resin-retaining device (104) grips the resin in the gap and prevents the gripped resin from slipping out with the molded article (114) during de-molding operation. FIG. 1B depicts a resultant reduced amount of crown flash resulting from using a textured gap finish.

It is understood that the scope of the present invention is limited to the scope provided by the independent claims, and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim. It is noted that the foregoing has outlined the non-limiting embodiments. Thus, although the description is made for particular non-limiting embodiments, the scope of the present invention is suitable and applicable to other arrangements and applications. Modifications to the non-limiting embodiments can be effected without departing from the scope of the independent claims. It is understood that the non-limiting embodiments are merely illustrative.

What is claimed is:

1. A mold-tool assembly (100), comprising:
a stem-tip portion (102); and
a resin-retaining device (104) being located relative to the stem-tip portion (102).

2. The mold-tool assembly (100) of claim 1, wherein:
the resin-retaining device (104) is configured to retain, at least partially, a gate-residing resin (116) in response to a molded article (114) breaking apart from the gate-residing resin (116) as the molded article (114) moves away from a gate orifice (106) during a de-molding operation.

3. The mold-tool assembly (100) of claim 1, wherein:
the stem-tip portion (102) is configured to interact with a gate orifice (106) being defined by a gate body (108), the gate orifice (106) leading to a mold cavity (110) being defined by a mold assembly (112), the mold cavity (110) being configured to receive a resin (113) and to form a molded article (114), and a gate-residing resin (116) becoming located in the gate orifice (106) in response to the stem-tip portion (102) being located in the gate orifice (106), the gate-residing resin (116) being connected with the molded article (114) being formed in the mold cavity (110); and
the resin-retaining device (104) is configured to retain, at least partially, the gate-residing resin (116) in response to the molded article (114) breaking apart from the gate-residing resin (116) as the molded article (114) moves away from the gate orifice (106) during a de-molding operation.

4. The mold-tool assembly (100) of claim 3, wherein:
the stem-tip portion (102) extends from a valve stem (118) being slidably received in a melt passageway (120) of a nozzle body (122).

5. The mold-tool assembly (100) of claim 3, wherein:
the stem-tip portion (102) is movable relative to the gate orifice (106).

6. The mold-tool assembly (100) of claim 3, wherein:
the resin-retaining device (104) includes:
a mold-gate textured surface (124) being located on the gate body (108) in the gate orifice (106), and the mold-gate textured surface (124) facing the stem-tip portion (102) once the stem-tip portion (102) is moved proximate to the mold-gate textured surface (124).

7. The mold-tool assembly (100) of claim 3, wherein:
the resin-retaining device (104) includes:
a stem-tip textured surface (126) being located on the stem-tip portion (102), and the stem-tip textured surface (126) facing the gate body (108) in the gate orifice (106) once the stem-tip portion (102) is moved proximate to the gate body (108).

8. The mold-tool assembly (100) of claim 3, wherein:
the resin-retaining device (104) includes:
a mold-gate textured surface (124) being located on the gate body (108) in the gate orifice (106), and the mold-gate textured surface (124) facing the stem-tip portion (102) once the stem-tip portion (102) is moved proximate to the mold-gate textured surface (124); and
a stem-tip textured surface (126) being located on the stem-tip portion (102), and the stem-tip textured surface (126) facing the gate body (108) in the gate orifice (106) once the stem-tip portion (102) is moved proximate to the gate body (108).

9. The mold-tool assembly (100) of claim 1, wherein:
the resin-retaining device (104) is realized by creation of a textured surface located on the stem-tip portion (102).

10. The mold-tool assembly (100) of any on of claims 7 and 8, wherein:
the stem-tip textured surface (126) is produced by any one of grit blasting, Electronic Discharge Manufacturing, etching, and machining.

11. The mold-tool assembly (100) of any on of claims 6 and 8, wherein:
the mold-gate textured surface (124) is produced by any one of grit blasting, Electronic Discharge Manufacturing, etching, and machining.

12. A molding system having the mold-tool assembly (100) of any one of claims 1 to 10.
